(19) United States
(12) Patent Application Publication
(10) Pub. No.: US 2007/0074013 A1
(43) Pub. Date: Mar. 29, 2007

(54) Dynamic retention of hardware register content in a computer system

(76) Inventor: Lonnie Goff, GROENEWOUDSEWEG 1, NL-5621 BA EINDHOVEN (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/569,199

(22) PCT Filed: Aug. 20, 2004
(86) PCT No.: PCT/IB04/51520

§ 371 Date: Nov. 21, 2006

Related U.S. Application Data
(60) Provisional application No. 60/497,725, filed on Aug. 25, 2003.

(51) Int. Cl. G06F 9/44

(52) U.S. Cl. 712/228

(57) ABSTRACT

A hardware register content retention system (100) includes a hardware register (110) configured to store register content and a memory (120) capable of storing multiple entries per register coupled to the hardware register, configured to receive a dump of the register content from the hardware register in response to initiation of a task interrupt and to restore the register content to the hardware register in response to termination of the task interrupt. The retention system also includes a controller (130) coupled to the hardware register and the memory, configured to control transfer of the register content between the hardware register and the memory. In one aspect of the invention, the memory is a first-in, first-out (FIFO) queue. The present invention enables more efficient retention of hardware register content than approaches implemented in software. Further, register content may be saved in parallel thereby increasing the speed of register content retention.

The present invention relates to the general field of hardware registers and more particularly to retention of hardware register content.

A register is a special, high-speed storage area, for example, within a central processing unit (CPU). All data must be represented in a register before it can be processed. For example, if two numbers are to be multiplied, both numbers must be in registers, and the result is also placed in a register. A register may contain the address of a memory location where data is stored rather than the actual data itself.

The number of registers that a CPU has and the size of each (in number of bits) help determine the power and speed of a CPU. For example a 32-bit CPU is one in which each register is 32 bits wide. Therefore, each CPU instruction can manipulate 32 bits of data.

Retention of contents stored in a register can be problematic. Retaining the contents of a register after a task switch (a switch between different tasks in a multithreading operating system), for example, presents obstacles. When a register is written by a new, interrupting task at a task switch, the previous contents of the register are destroyed. Thus, the previous register contents are not available in the register when the previous task resumes.

The conventional approaches to this problem of register content retention employ slow and somewhat cumbersome software solutions. The software solutions may either read and save the contents of a register whose history must be preserved or prevent those types of conditions that could cause the contents of a register to be overwritten.

An example of the first type of conventional software solution to the register content retention problem can be seen in the context of a task switch in a computer system. At the task switch, the operating system software stores the contents of all the CPU's general-purpose registers in memory before the new task is given program control. Upon completion of the interrupting task, the saved contents are restored to the registers. Storing the register contents in memory and then restoring them to the registers in this way is a time-consuming serial operation.

An example of the second type of conventional software solution to the register content retention problem can be seen where software must access multiple registers in a subsystem in a single atomic operation. This type of access occurs when an index register is used to address a data register within a single subsystem. Typically, to perform this type of access, some sort of resource locking scheme will be implemented in software. In the resource-locking scheme, the first task to grab the resource lock owns the index register until the task relinquishes the resource lock. Other tasks needing to use the same resource lock are effectively idled, thereby creating a bottleneck. Thus, this conventional approach is very inefficient.

Thus, a faster, more efficient way to retain register content is needed.

A hardware register content retention system includes a hardware register configured to store register content and a memory capable of storing multiple entries per register coupled to the hardware register, configured to receive a dump of the register content from the hardware register in response to initiation of a task interrupt and to restore the register content to the hardware register in response to termination of the task interrupt. The retention system also includes a controller coupled to the hardware register and the memory, configured to control transfer of the register content between the hardware register and the memory. In one aspect of the invention, the memory is a first-in, first-out (FIFO) queue.

The present invention dynamically retains hardware register content. The disclosed techniques enable more efficient register content retention than conventional approaches implemented in software. Further, saving register content to the memory may be performed in parallel. Saving register content in parallel increases the speed of register content retention over conventional approaches where register content is saved in series. Additionally, the retention system does not require implementation of resource-locking schemes, which can potentially cause bottlenecks.

The invention is described with reference to the following figures:

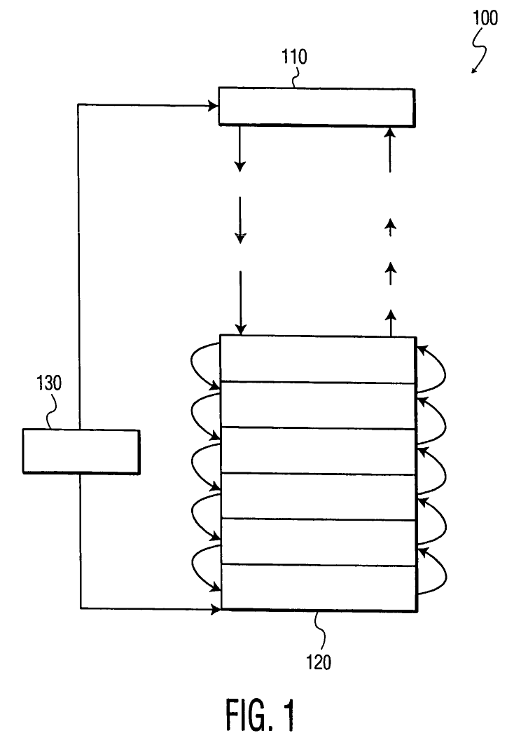

FIG. 1 is a logical depiction showing a hardware register content retention system, according to an embodiment of the present invention;

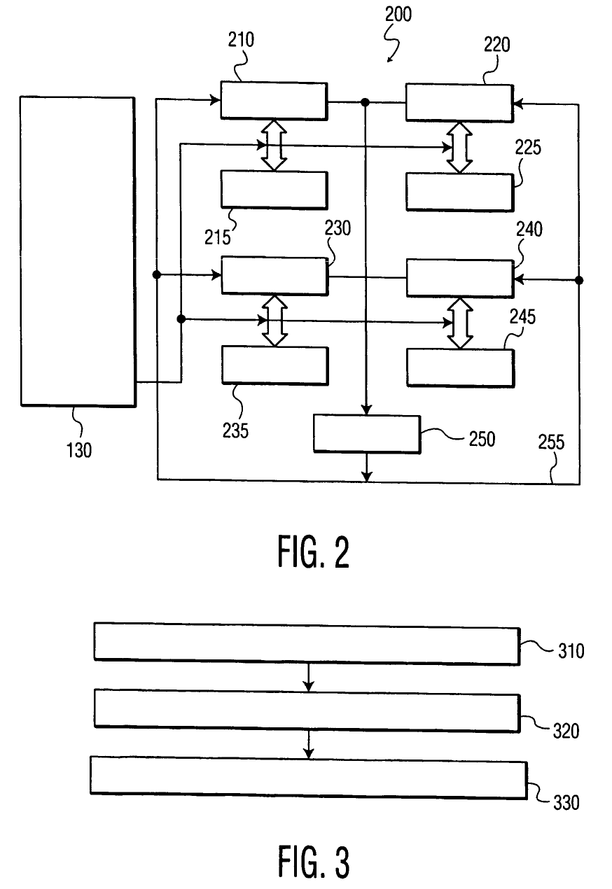

FIG. 2 is a logical depiction showing a hardware register content retention system, according to another embodiment of the present invention; and

FIG. 3 is a flow diagram showing a method for retaining hardware register content, according to an embodiment of the present invention.

### DETAILED DESCRIPTION

The invention is described with reference to specific apparatus and embodiments. Those skilled in the art will recognize that the description is for illustration and to provide the best mode of practicing the invention.

FIG. 1 is a logical depiction of a hardware register content retention system 100 (retention system), according to an embodiment of the present invention. The retention system uses a memory capable of storing multiple entries per register to retain hardware register content. The retention system includes a hardware register 110, a memory 120, and a controller 130. The hardware register stores register content, such as for example memory pointers. The memory is coupled to the hardware register and is configured to receive a dump of the register content from the hardware register in response to a task interrupt. The memory restores the register content to the hardware register in response to termination of the task interrupt.

In one embodiment of the present invention, the memory 120 is a first-in, first-out (FIFO) queue. A FIFO queue is a data structure in which elements are removed in the same order they were entered, i.e. on a first-in, first-out basis. In one aspect of the present invention, the FIFO queue is a dedicated memory system incorporated within a hardware register. The FIFO queue may be relatively small, on the order of two or more register entries. The controller is coupled to the hardware register and the FIFO queue and is configured to control transfer of the register content between the hardware register and the FIFO queue. Although the term “FIFO queue” is used throughout the description to identify the memory 120, it shall be understood that the FIFO queue may be replaced with any other type of memory capable of storing multiple entries per register, such as for example, a last-in, first-out (LIFO) stack.

A task interrupt is synonymous with a task switch. A task switch is a switch between different tasks for the use operating system resources. When the register is in a stasis, that is, when the register is processing one task and no task switch is occurring, nothing is saved or retrieved from the FIFO queue by the register. However, at the incidence of a task switch, the FIFO queue is utilized.

When the task switch occurs, the content of the register is dumped onto the FIFO queue. In one embodiment of the present invention, the register dump is implemented using a “PUSH_ALL” computer instruction executed by the controller. In one aspect of the invention, when the controller decodes the PUSH_ALL instruction, the register dump to the FIFO queue is triggered.

When the task switch is finished, that is, when the interrupting task is completed the register values that had been stored to the FIFO queue are restored to the register. In one embodiment of the present invention, the restoration of the saved register values from the FIFO queue to the register is implemented using a “POP_ALL” computer instruction executed by the controller. The execution of the POP_ALL instruction by the controller “pops” the stored register values from the FIFO queue and restores them to the register.

In one aspect of the present invention, the hardware registers used with the retention system are index registers. In this aspect, a FIFO queue coupled to an index register may store previous contents of the index register as new contents are written to the index register. The previous contents of the index register may be retained in the FIFO queue until the new task reads the index register. When the new task reads the index register, the previous contents of the index register are restored to the index register from the FIFO queue. Thus, an interrupting task does not harm the previous contents of the index register. In implementation of this aspect of the present invention, the previous contents of the index register may be automatically saved to the index register's dedicated FIFO queue when new contents are written to the index register. Once a data register that was specified by the index register is accessed, a hardware decode of the data register address space may trigger an automatic restoration of the contents of the index register from its dedicated FIFO queue. Alternatively, the contents of the index register may be restored only when the index register is read by software. In this alternative scenario, a hardware decode logic that automatically triggers restoration of index register content is not needed.

In another aspect of the present invention, the retention system is used in connection with general-purpose central processing unit (CPU) registers. In this aspect, all of the general-purpose CPU registers may be coupled to their own individually dedicated FIFO queues. When the associated operating system responds to an exception, the contents of all of the CPU registers are saved when a single ‘global save’ instruction is executed. This save process is a very fast parallel operation that causes the contents of each CPU register to be written together in real time into the dedicated FIFO queue related to each CPU register. When program control returns from the exception handler, the CPU registers are all restored by a single ‘global restore’ instruction, which is another very fast parallel operation. The use of the retention system in connection with CPU registers is described further below with reference to FIG. 2.

FIG. 2 is a logical depiction of a hardware register content retention system 200 (retention system), according to another embodiment of the present invention. Whereas the retention system 100 described with reference to FIG. 1 had simply one register with one dedicated FIFO queue, the retention system 200 described with reference to FIG. 2 includes multiple registers, where each register has a dedicated FIFO queue. The retention system 200 is implemented in connection with CPU registers and includes the controller 130 (instruction and decoder control logic), a first register 210, a first FIFO queue 215, a second register 220, a second FIFO queue 225, a third register 230, a third FIFO queue 235, a fourth register 240, a fourth FIFO queue 245, and an arithmetic logic unit 250 (ALU). The first register, the first FIFO queue, the second register, the second FIFO queue, the third register, the third FIFO queue, the fourth register, the fourth FIFO queue, and the ALU are coupled via an internal bus 255.

The first FIFO queue is coupled to the first register and acts as a dedicated FIFO queue for the first register. The second FIFO queue is coupled to the second register and acts as a dedicated FIFO queue for the second register. The third FIFO queue is coupled to the third register and acts as a dedicated FIFO queue for the third register. The fourth FIFO queue is coupled to the fourth register and acts as a dedicated FIFO queue for the fourth register. The controller is coupled to the first register, the first FIFO queue, the second register, the second FIFO queue, the third register, the third FIFO queue, the fourth register, and the fourth FIFO queue. The controller executes PUSH_ALL and POP_ALL instructions to turn on the dedicated FIFO queues and cause data to pass between the CPU registers and their respective dedicated FIFO queues. The ALU is coupled to the first register, the first FIFO queue, the second register, the second FIFO queue, the third register, the third FIFO queue, the fourth register, and the fourth FIFO queue. The ALU performs arithmetic operations such as addition and subtraction and/or logical operations such as AND and OR using content stored in the registers.

FIG. 3 is a flow diagram of a method for retaining hardware register content, according to an embodiment of the present invention. At step 310, register content is stored in a hardware register. In one aspect of the present invention, the register content may include any number of individual register items. At step 320, the register content is pushed onto a FIFO queue from the hardware register based at least in part on initiation of a task interrupt (task switch). At step 330, the register content is popped back onto the hardware register from the FIFO queue based at least in part upon termination of the task interrupt. In one aspect of the present invention, all of the individual register items included in the register content are pushed and/or popped together in real time.

Hardware register content may be dynamically retained using several different approaches. In a first approach, a dedicated FIFO queue is coupled to the hardware register. A write operation causes the current value of the hardware register to be saved to its dedicated FIFO queue. Then, a read operation of the hardware register causes the last value saved in the FIFO queue to be loaded back into the hardware register.

In a second approach, a dedicated FIFO queue is coupled to the hardware register. A write operation causes the current value of the hardware register to be saved to its dedicated FIFO queue. Then, a hardware decode of a specific event automatically triggers restoration of the last value saved in the FIFO queue to the hardware register.

In a third approach, a dedicated FIFO queue is coupled to the hardware register. A hardware decode of a specific event automatically triggers saving of the current register contents to the FIFO queue. Then, a hardware decode of another specific event automatically triggers restoration of the last value saved in the FIFO queue to the hardware register. Not all read operations are destructive. Whether or not a read operation is destructive depends upon which approach is used. In the first approach, the read operation is destructive. In the second and third approaches, the read operation is not destructive. The three approaches listed here are exemplary only. Other approaches are also contemplated.

Advantages of the invention include that the present invention dynamically retains hardware register content. The disclosed techniques enable more efficient register content retention than conventional approaches implemented in software. Further, saving register content to the FIFO queue is performed in parallel. Saving register content in parallel increases the speed of register content retention over conventional approaches where register content is saved in series. Additionally, the retention system does not require implementation resource locking schemes, which can potentially cause bottlenecks.

Having disclosed exemplary embodiments and the best mode, modifications and variations may be made to the disclosed embodiments while remaining within the subject and spirit of the invention as defined by the following claims.

1. A hardware register content retention system comprising: a hardware register configured to store register content; a memory capable of storing multiple entries per register and coupled to the hardware register, configured to receive a dump of the register content from the hardware register in response to initiation of a task interrupt and to restore the register content to the hardware register in response to termination of the task interrupt; and a controller coupled to the hardware register and the memory, configured to control transfer of the register content between the hardware register and the memory.

2. The system of claim 1, wherein the dump of the register content from the hardware register is based at least in part upon execution of a PUSH_ALL computer instruction by the controller.

3. The system of claim 2, wherein the restoration of the register content to the hardware register is based at least in part upon execution of a POP_ALL computer instruction by the controller.

4. The system of claim 1, wherein the memory is a first-in, first-out queue.

5. The system of claim 4, wherein the dump of the register content from the hardware register is based at least in part upon execution of a PUSH_ALL computer instruction by the controller.

6. The system of claim 5, wherein the restoration of the register content to the hardware register is based at least in part upon execution of a POP_ALL computer instruction by the controller.

7. The system of claim 1, wherein the hardware register is selected from the group consisting of: an index register; and a general-purpose central processing unit register.

8. A method for retaining hardware register content during a task interrupt, comprising: storing register content in a hardware register pushing the register content from the hardware register onto a memory capable of storing multiple entries per register based at least in part on initiation of the task interrupt; and popping the register content back onto the hardware register from the memory based at least in part upon termination of the task interrupt.

9. The method of claim 8, wherein the initiation of the task interrupt comprises a write operation to the hardware register.

10. The method of claim 8, wherein the initiation of the task interrupt comprises a hardware decode of a specific event.

11. The method of claim 8, wherein the termination of the task interrupt comprises a read operation from the hardware register.

12. The method of claim 8, wherein the termination of the task interrupt comprises a hardware decode of a specific event.
